(19) United States
(12) Patent Application Publication
(10) Pub. No.: US 2025/0021314 A1
(43) Pub. Date: Jan. 16, 2025

(54) Automated Generation of Artificial Intelligence and Machine Learning Training Datasets from Existing Media Using Time Codes and Scripts

(71) Applicant: Graeme Dylan Hamilton, Dallas, TX (US)

(72) Inventor: Graeme Dylan Hamilton, Dallas, TX (US)

(73) Assignee: Graeme Dylan Hamilton, Dallas, TX (US)

(21) Appl. No.: 18/351,832

(22) Filed: Jul. 13, 2023

(51) Int. Cl. G06F 8/35

(52) U.S. Cl. CPC G06F 8/35

(57) ABSTRACT

The present utility patent application describes an automated program designed to generate Artificial Intelligence or Machine Learning training datasets from audio, visual and audio-visual media by utilizing scripts and the time codes and associated image/video/audio media content developed from these scripts. Through automatic matching of the script to the final content, large amounts of sound, image and video samples can be programmatically associated with descriptive text. By integrating these elements, the process enables the efficient and accurate creation of diverse and representative datasets for training Artificial Intelligence or Machine Learning models. This invention revolutionizes the process of dataset generation for Artificial Intelligence or Machine Learning training, enhancing efficiency, accuracy, and customization capabilities.

### BACKGROUND OF THE INVENTION

In the field of Artificial Intelligence and Machine Learning, the creation of reliable training datasets is a time-consuming and labor-intensive task. Manual extraction and curation methods are prone to human error and are not scalable for large-scale applications. The use of time codes, scripts, and media content to programmatically generate these datasets offers a novel approach. Previous solutions have not adequately addressed the need for an automated process. Hence, there is a demand for an innovative process that seamlessly combines time codes, scripts, and media content to generate Artificial Intelligence or Machine Learning training datasets.

### SUMMARY OF THE INVENTION

The proposed invention introduces an automated process for generating Artificial Intelligence or Machine Learning training datasets from image/video/audio media content. By utilizing time codes, scripts, and associated image/video/audio content, the process facilitates efficient and accurate dataset creation. The process extracts relevant information from the media content and processes it to generate datasets.

### DETAILED DESCRIPTION OF THE INVENTION

### System Architecture

The process's overall structure integrates time codes, scripts, and media content using hardware and software components, including processors and storage systems, to facilitate seamless data processing.

### Data Processing

The process employs detailed algorithms and methodologies to process time codes, scripts, and media content. Various techniques, such as text analysis, audio/video processing, and image recognition, are utilized to extract relevant information. The extracted data is then prepared and transformed into suitable formats for dataset generation.

### Artificial Intelligence or Machine Learning Training Dataset Generation

The process utilizes the processed data to generate Artificial Intelligence or Machine Learning training datasets. It applies rules, criteria, and heuristics to ensure dataset quality and relevance. Considerations may include data diversity, representative sampling, and annotation methods that facilitate accurate training.

1. A process for automated generation of Artificial Intelligence or Machine Learning training datasets from existing media that uses time codes, scripts, and image/video/audio content ingestion for programmatic dataset generation.
